(19) United States
(12) Patent Application Publication
(10) Pub. No.: US 2015/0300508 A1
(43) Pub. Date: Oct. 22, 2015

(54) Valve Seat for Floating Ball Valve

(71) Applicant: Zenghua He, Shanghai (CN)

(72) Inventor: Zenghua He, Shanghai (CN)

(21) Appl. No.: 14/451,940

(22) Filed: Aug. 5, 2014

(30) Foreign Application Priority Data
Apr. 22, 2014 (CN) 201410163868.3

(51) Int. Cl. F16K 5/06; F16K 5/20

(52) U.S. Cl. CPC F16K 5/0684; F16K 5/0647; F16K 5/20

(57) ABSTRACT

The present invention discloses a type of valve seats for a floating ball valve, the valve seats are connected to a valve body both ends of the floating ball valve through elastic elements, and when the floating ball valve is closed, both a ball of the floating ball valve and the valve seats move in the valve body cavity in order to seal.

### CROSS-REFERENCE TO RELATED APPLICATIONS

The present application claims priority under 35 U.S.C. §119 to Chinese patent application 201410163868.3, filed Apr. 22, 2014, the disclosure of which is incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

The present application claims priority under 35 U.S.C. §119 to Chinese patent application 201410163868.3, filed Apr. 29, 2014, the disclosure of which is incorporated herein by reference.

### BACKGROUND

1. Technical Field

The present invention relates to a valve used for fluid control, and in particular, to a type of valve seats for a floating ball valve.

2. Related Art

In the prior art, a ball valve may be classified into a floating ball valve and a trunnion ball valve. The trunnion ball valve refers to that a ball position of the trunnion ball valve is not floating or moving, and valve seats thereof are movable. During operations, a force applied by a fluid medium from the inlet of the valve on the ball is completely transferred to a valve stem, so that the ball does not move towards the valve seats, and therefore, the valve seats do not bear an over-large pressure. As a result, the trunnion ball valve has a small torque, small valve seat deformation, stable sealing performance, and a long service life, and is applicable to a scenario with a high pressure and a large size. However, generally speaking, to fix the ball position, the trunnion ball valve has a more complicated structure, and has a more complicated manufacturing process than those of the floating ball valve.

The floating ball valve refers to that a ball of the ball valve is floating or movable, and the ball may generate a certain displacement under a medium pressure to press against a sealing surface of an outlet end, so as to ensure sealing of the outlet end. Greater pressure results in better sealing performance, but a torque used for opening and closing increases along with the increase of the pressure. The floating ball valve has a simple structure and good sealing performance, but the working pressure by the medium born by the ball is completely transferred to valve seats, and therefore, it should be taken into consideration whether the valve seats can withstand the working pressure from the valve ball through the medium; when being pressed by a high pressure, soft material of the valve seats offsets, thereby causing reduction of sealing effect. Therefore, this structure is generally used in a scenario with a medium-low pressure and a small size valve.

Compared with the trunnion ball valve, the floating ball valve has a simpler structure, a simpler manufacturing process and a lower cost; however, all pressure is born by the valve seats, a drive force required for opening and closing the floating ball valve is very large. On the other hand, when the torque for opening is large, the intensity of pressure born by the valve seats is increased, which easily damages the valve seats to cause leakage of the medium. Even though if the valve seats are not damaged, friction between the ball and the valve seats is increased as well, which causes wear of the valve seats, thereby reducing the service life of the valve.

In view of the above, a new type of valve seats for a floating ball valve capable of overcoming the above defects is required in the prior art.

### SUMMARIZED DESCRIPTION

In order to overcome the defects in the prior art, the present invention provides a type of valve seats for a floating ball valve, where when the floating ball valve is closed, the valve seats can move in a medium while the valve ball is moving at the same time.

To achieve the object of the present invention, the present invention discloses a type of valve seats for a floating ball valve, where the valve seats are connected to a valve body of the floating ball valve through elastic elements, and when the floating ball valve is closed, a ball of the floating ball valve and the valve seats both move inside a valve body cavity.

Further, the elastic elements include multiple coil springs, one end of the coil springs is connected behind the valve seats, and the other end of the coil springs is connected to the valve body, so that the originally fixed valve seats can move freely inside the valve body.

Further, the valve seats are made of rigid materials. The valve seats are made of metal or ceramic. The valve seats contact with the ball through soft materials. A surface of the valve seat facing the ball is a plane or a spherical surface. A surface of the valve seat facing the ball includes a first groove, and the first groove is used to embed the soft material. A surface of the valve seat facing the ball includes a second groove, and the soft material is embedded in both the first and the second groove. The soft sealing material can also be sprayed on the surface of the valve seat or bonded onto the surface of the valve seat through another process. A surface of the valve seat outer edge facing the valve body includes a third groove, and the third groove is used to embed a seal ring made of a soft material for sealing between the valve seats and the valve body.

Compared with the prior art, the following advantages can be implemented:

Firstly, the pressure from a fluid medium is distributed to multiple different parts, the floating ball valve provided with such type of valve seats can be used in a pipeline with a larger size and in an environment with a higher pressure; secondly, because both the ball and the valve seats are floating and movable, the valve seats do not need to be moved away in advance before the floating ball valve is being opened, a low torque can be implemented only by self-adjusting positions of the ball and the valve seats, and therefore, the floating ball valve can be easily opened; thirdly, the valve seats are made of rigid materials, and the pressure is distributed to multiple different parts, so that the floating ball valve has a longer service life and a more stable structure; fourthly, the floating ball valve using the valve seats provided in the present invention can be used in severe environments with greatly changed temperatures, pressures, and so on; and fifthly, if the valve seats of the present invention are made of a rigid material and a surface thereof in contact with the ball is sprayed or of a thin structure, the large torque for opening and closing the floating ball valve can be greatly reduced, this is because the rigid valve seats directly bear the medium pressure, and friction generated between the ball and the valve seats when they move during opening and closing is born by the plastic material having an extremely small friction coefficient.

### BRIEF DESCRIPTION OF THE DRAWINGS

Advantages and spirit of the present invention may be further understood through detailed description of the present invention and accompanying drawings as follows:

FIG. 1 is a schematic structural view of a floating ball valve according to the prior art;

FIG. 2 is a schematic structural view of a first embodiment of valve seats for a floating ball valve according to the present invention;

FIG. 3 is a schematic structural view of a second embodiment of valve seats for a floating ball valve according to the present invention;

FIGS. 4 (a) and (b) are schematic structural views of surfaces of valve seats of a second embodiment of valve seats for a floating ball valve according to the present invention; and,

FIGS. 5 (a) and (b) are schematic structural views of surfaces of valve seats of a third embodiment of valve seats for a floating ball valve according to the present invention.

### DETAILED DESCRIPTION

A valve seat in a specific embodiment of the present invention is described in detail with reference to the accompanying drawings. However, it should be understood that, the present invention is not limited to the described embodiment, and technical ideas of the present invention can be implemented in combination with other well-known technologies or other technologies having functions the same as those of the well-known technologies.

In the following description, in order to clearly show the structure and working manner of the present invention, many directional terms are used; however, it should be understood that, those words such as “front”, “back”, “left”, “right”, “inner”, “outer”, “outwards”, “inwards”, “axial”, and “radial” are only used for ease of illustration instead of limiting the present invention.

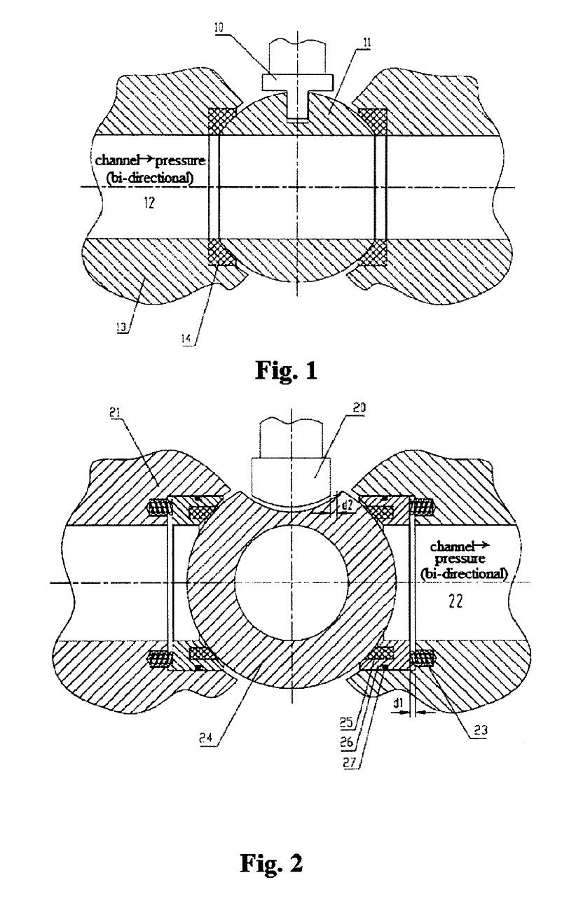

FIG. 1 shows an open state of a floating ball valve in the prior art, where 10 represents a valve stem, 11 represents a ball, 12 represents a media channel, 13 represents a valve body, and 14 represents a valve seat. In the prior art, the (2) valve seats 14 used in the floating ball valve must be made of plastic materials; otherwise, sealing cannot be achieved in a closed state of the floating ball valve. In the open state of the floating ball valve, a medium flows through the medium channel 12 and the ball 11. In the prior art, when the ball valve is opened from a closed state, it is ideal that the torque of the valve stem can be reduced as much as possible, so as to reduce the drive force required for opening, to reduce the wear of the valve seats, and to avoid reduction of sealing performance. In order to reduce the opening torque of the valve stem, a friction between the valve seats and the ball must be minimal.

FIG. 2 is a schematic structural view of valve seats used in a floating ball valve according to the present invention. The floating ball valve shown in FIG. 2 is in a closed state. A valve body forms a valve body cavity, and the ball and the valve seats are both assembled in the valve body cavity. When the floating ball valve is opened, the valve body cavity is filled with a medium, and the medium flows through a ball 24 and a channel 22. In the present invention, the ball 24 and the valve seats 26 may both move in the valve body cavity, and therefore, after the medium enters the valve, the floating ball 24 is sealed with the movable valve seats 26 under the pressure of the medium in the ball cavity. Because the valve seats 26 are connected to the valve body both ends through elastic elements 23, when the pressure born by the valve seats 26 is increased, the elastic elements 23 absorb partial of the pressure. A gap d1 is formed between the valve seat 26 and one end of the valve body 21. When the pressure generated by the medium in the channel 22 gradually increases, the ball 24 is pushed to move. A movable range d2 of the ball in the channel is greater than the movable range d1 of one of the valve seats. When the valve seat 26 move to a limit, the valve seat 26 presses against the valve body 21 and the elastic elements 23 at the same time, and therefore, the pressure between the ball and the valve seats is distributed to three different parts including the valve seats, the elastic elements and the valve body, and the pressure distribution inside the cavity is also changed. Therefore, compared with the prior art, the ball valve provided in the present invention in which the ball and the valve seats are both floating is more suitable for an environment with a larger size and a higher pressure.

In the floating ball valve provided in the present invention, when the valve stem 20 starts rotating, because of the friction between the valve seats 26 and the ball 24, springs 23 are pressed automatically to deform, and the springs absorb the friction through deformation; therefore, the torque during opening is greatly reduced. In the prior art, the valve seats cannot move and bears all the medium pressure, the friction is obviously large, so that the wear of the valve seats is increased after multiple times of opening and closing.

In the prior art, the valve seats used in the floating ball valve must be made of plastic materials; otherwise, sealing effect cannot be achieved. In the present invention, the valve: seats 26 are also floating in the valve body cavity, so that the valve seats in the present invention are made of rigid materials, such as metal and ceramic, and contact surfaces between the valve seats and the ball are covered by a plastic material which has a smaller friction coefficient. In this way, the service life of the valve seats is enhanced, but the friction pressure is not increased, thereby reducing the risk of poor sealing effect due to damage of the valve seats. In another preferred embodiment, to achieve an optimal sealing effect, a groove is formed in a surface of the valve seats 26 facing the ball, and the groove 25 is used to embed a seal component made of a plastic material. In this way, when the ball 24 contacts with the valve seats 26, the medium will not flow through between the ball and the valve seats because of the existence of the plastic seal components, and because the plastic seal components have small deformation under the pressure, the plastic material on the surface of the valve seats is not severely damaged after the ball is tightly pressed against the valve seats 26. Moreover, another groove 27 is further formed in an surface of the valve seat outer edge 26 connected to the valve body 21, so as to embed a seal ring of an O shape, a V shape, or other shapes. Compared with the prior art, the floating ball valve provided in the present invention can be applied to an environment with dramatically changed temperatures and pressures, this is because when low temperature occurs, materials of the ball valve have different thermal expansivity, and due to cold contraction and deformation, the floating ball and the floating valve seats self-adjust the pressure mutually; therefore, no manual intervention is required, and good sealing effect is achieved automatically. When the pressure increases, the pressure is distributed to multiple different parts, thereby avoiding deformation of a single part due to overload.

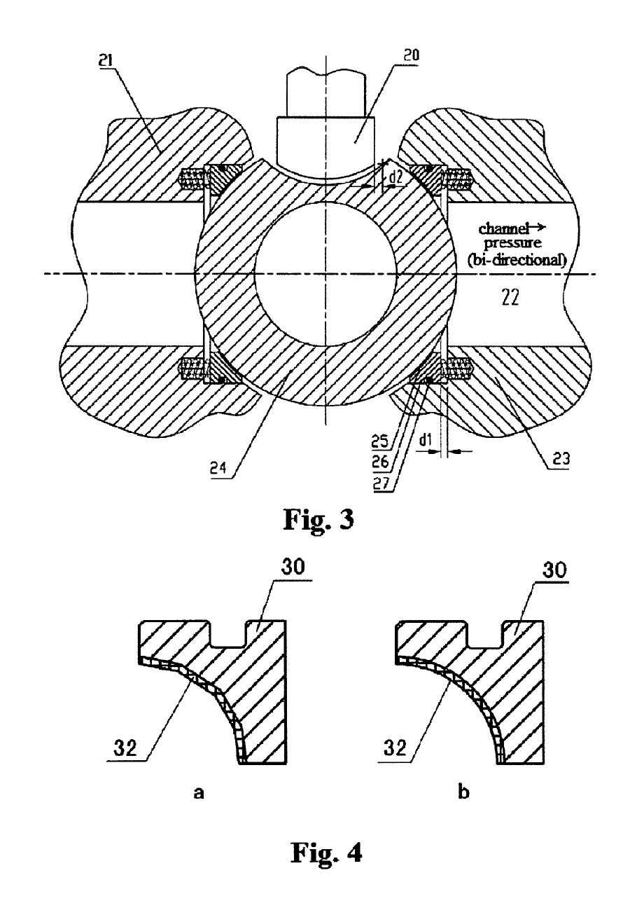

FIG. 3 is a second embodiment of the present invention, and compared with the first embodiment, the valve seats shown in FIG. 3 has a more compact structure and lower assembling cost. When the seal ring in FIG. 2 is pressed by the ball 24 to deform, in order to avoid the seal ring 25 from falling out of the groove 25, the groove 25 must be big enough, so that the valve body cavity of the whole floating ball valve is increased, which further causes the increase of the valve body size, and increases the manufacturing cost. In the second embodiment, a soft material 32, such as rubber, Teflon and nylon, is sprayed directly, on surfaces of rigid valve seat 30 and the ball. In FIG. 4(a), a surface of the valve seat 30 in contact with the ball may be one or more planes. In FIG. 4(b), a surface of the valve seat 30 in contact with the ball may be a spherical surface. Compared with the planar contact surface, when the contact surface is a spherical surface, a junction of the ball and the valve seat is changed from a point to a surface, so as to reduce the intensity of pressure.

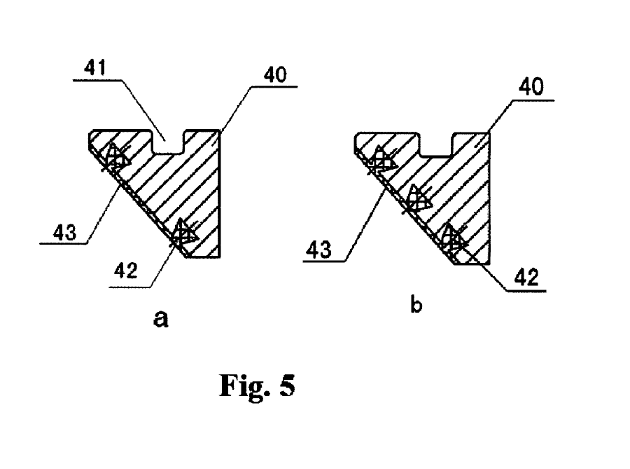

FIG. 5 is a third embodiment of the present invention, and compared with the second embodiment, the third embodiment makes further improvements. In the second embodiment, the soft material has been fixed to the metal valve seat through processes such as spraying and sintering during manufacturing; however, if the floating ball valve works in an environment with dramatically changed temperatures and pressures, the soft material may be separated from the metal valve seat. Therefore, in the third embodiment, a surface of a valve seat 40 in contact with the ball is additionally provided with two grooves 42, and a soft material 43 is embedded in the grooves. Preferably, the groove is a trapezoidal groove or a circular groove (not shown), and an opening of the groove is smaller than the bottom thereof, so as to catch the soft material 43. In FIG. 5(a) and FIG. 5(b), forms of the surface of the valve seat 40 in contact with the ball is the same as those in FIG. 4(a) and FIG. 4(b), and the surface may be a plane, multiple planes or a spherical surface. In FIG. 5(a), two grooves are disposed, and in FIG. 5(b), three grooves are disposed. Technical professionals in the art should know that the number of the grooves may be obtained through calculation according to the pressure that the valve seat needs to bear and a specification of the valve seat, and is not intended to limit the present invention.

What are described in the specification are preferred embodiments of the present invention, and the embodiments are only used for describing the technical solution of the present invention instead of limiting the present invention. Technical solutions that can be made by technical professionals in the art according to the present invention through logic analysis, ratiocination or limited experiment should all fall within the scope of the present invention.

We claim:

1. Valve seats for a floating ball valve, comprising:
a ball of the floating ball valve body;
a valve body of a floating ball valve, said valve body is provided with a valve body cavity;
the valve seats are connected to the valve body of the floating ball valve through elastic elements,
and when the floating ball valve is closed, both the ball of the floating ball valve and the valve seats move inside the valve body cavity.

2. The valve seats for the floating ball valve according to claim 1, wherein the elastic elements comprise multiple coil springs, one end of the coil springs is connected behind the valve seats, and a second end of the coil springs is connected to the valve body.

3. The valve seats for the floating ball valve according to claim 1, wherein the valve seats are made of a rigid material.

4. The valve seats for the floating ball valve according to claim 1, wherein the valve seats are made of metal or ceramic.

5. The valve seats for the floating ball valve according to claim 1, wherein the valve seats contact with the ball through a soft material.

6. The valve seats for a floating ball valve according to claim 1, further comprising a surface of the valve seats facing the ball is one or more planes or a spherical surface.

7. The valve seats for a floating ball valve according to claim 1, further comprising
a soft material through which the valve seats contact with the ball;
and, a surface of the valve seats facing the ball comprises a first groove, and the first groove is used to embed the soft material.

8. The valve seats for a floating ball valve according to claim 7, wherein a surface of the valve seats facing the ball comprises a second groove, and the soft material is embedded inside both the first and the second grooves.

9. The valve seats for a floating ball valve according to claim 1, further comprising a soft material through which the valve seats contact with the ball, wherein the soft material is sprayed or bonded onto a surface of the valve seats.

10. The valve seats for a floating ball valve according to claim 1, wherein a surface of the valve seat outer edge facing the valve body comprises a third groove, and the third groove is used to embed a seal ring.
